(19) United States
(12) Patent Application Publication
(10) Pub. No.: US 2008/0036815 A1
(43) Pub. Date: Feb. 14, 2008

(54) Device for adjusting printing heads of printing machine

(75) Inventors: Jih-Chiang Yu, Hsi Chih City (TW); Meng-Chou Hsieh, Hsi Chih City (TW); Hsien-Chang Lin, Hsi Chih City (TW); Chih-Te Yu, Hsi Chih City (TW)

Correspondence Address: TROXELL LAW OFFICE PLLC, 5205 LEESBURG PIKE, SUITE 1404, FALLS CHURCH, VA, 22041, US

(73) Assignee: Great Computer Corporation

(21) Appl. No.: 11/502,504

(22) Filed: Aug. 11, 2006

(51) Int. Cl. B41J 2/015

(52) U.S. Cl. 347/20

(57) ABSTRACT

An adjusting device for adjusting printing heads of inkjet printing machine includes a base connected to a printing unit and a plurality of printing assemblies are respectively connected to the base. Each printing assembly has a printing head connected thereto and a connection board is connected to an end wall of each printing assembly. Three adjusting members extend through the end board and contact against the end wall, and the three adjusting members are located at three peaks of an imaginary right triangle on the end board so as to adjust the printing head in different directions. A fourth adjusting member extends through the end board and is fixed to the end wall. The fourth adjusting member is located at a center of weight of the imaginary right triangle.

### FIELD OF THE INVENTION

The present invention relates to an adjusting device for adjusting the printing heads to correct positions.

### BACKGROUND OF THE INVENTION

A conventional inkjet printing machine is able to print precise colors to obtain a photo-level printing quality by controlling the printing heads. The modern printing machine provides satisfied printing quality and the precise colors can be easily obtained by operating computers. In order to obtain desired colors, the printing heads have to be adjusted so that the ink can be injected on the paper sheets as desired. The printing heads are connected to a printing unit which is movable along a rail of the printing machine. However, there are tolerance when installing the printing heads one by one to the printing unit so that experienced technician has to carefully adjust the position of each of the printing heads. This is a time-consuming task and affects the final result. If the printing heads are not well adjusted, the final result might include twisted color phases and/or uneven lines.

The present invention intends to provide an adjusting device which includes four adjusting members to adjust the printing heads in three directions.

### SUMMARY OF THE INVENTION

The present invention relates to an adjusting device for adjusting printing heads of inkjet printing machine, and the adjusting device comprises a base connected to a printing unit and the base has an engaging space with which a plurality of printing assemblies are respectively engaged. Each printing assembly has a printing head connected thereto and a connection board is connected to an end wall of the printing assembly. A first adjusting member, a second adjusting member, a third adjusting member and a fourth adjusting member are respectively connected to the connection board of each printing assembly. The first, second and third adjusting members extending through the end board and contact against the end wall. The first, second and third adjusting members adjust the printing head. The first, second and third adjusting members are located at three peaks of an imaginary right triangle on the end board. The fourth adjusting member is located at a center of weight of the imaginary right triangle and fixedly connected to the end wall.

The primary objective of the present invention is to provide an adjusting device for an inkjet printing machine, wherein the printing head can be adjusted in three directions by rotating the adjusting members on each of the printing assemblies.

The present invention will become more obvious from the following description when taken in connection with the accompanying drawings, which show for purposes of illustration only a preferred embodiment in accordance with the present invention.

### BRIEF DESCRIPTION OF THE DRAWINGS

FIG. 1 is a perspective view to show the adjusting device of the present invention;

FIG. 2 is a perspective view to show the adjusting assembly of the present invention;

FIG. 3 is an exploded view to show the adjusting assembly of the present invention;

FIG. 4 is a perspective view to show that the printing head is connected to the adjusting assembly of the present invention;

FIG. 5 shows that the adjusting device is composed of multiple printing head and adjusting assemblies, and

FIG. 6 shows that the printing unit of the present invention.

### DETAILED DESCRIPTION OF THE PREFERRED EMBODIMENT

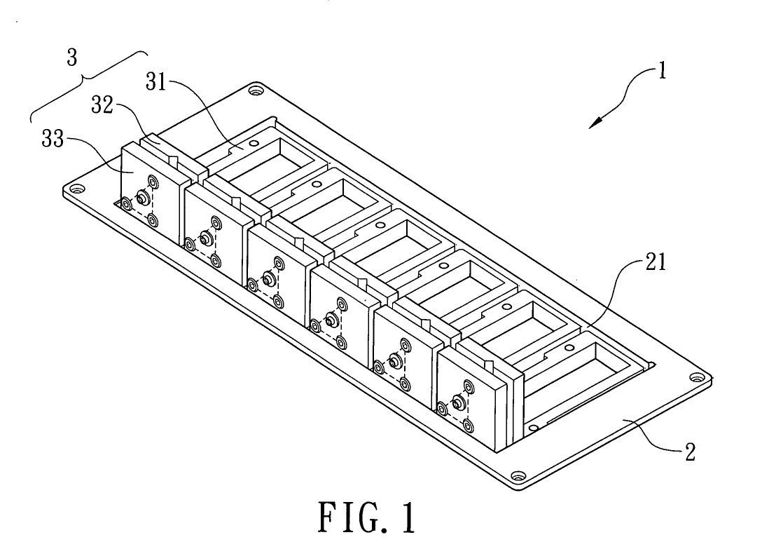

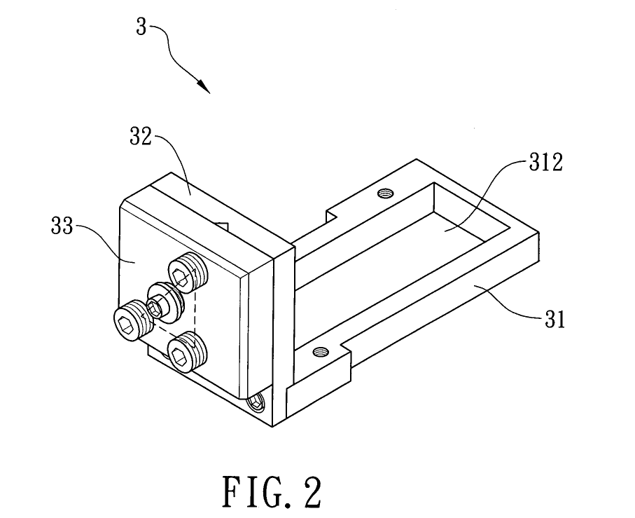

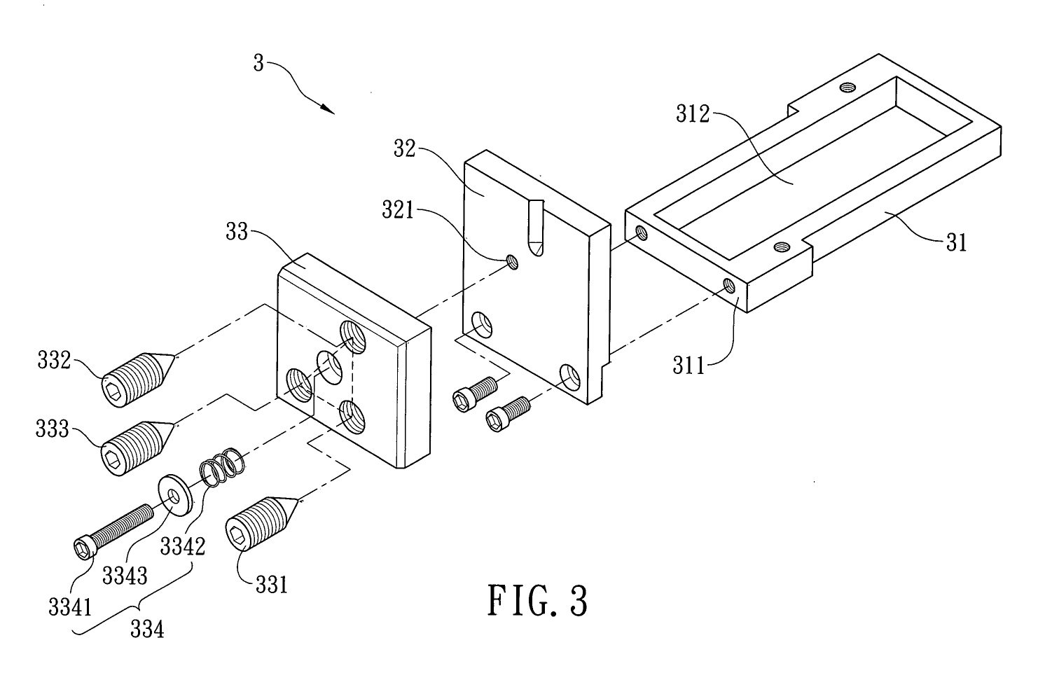

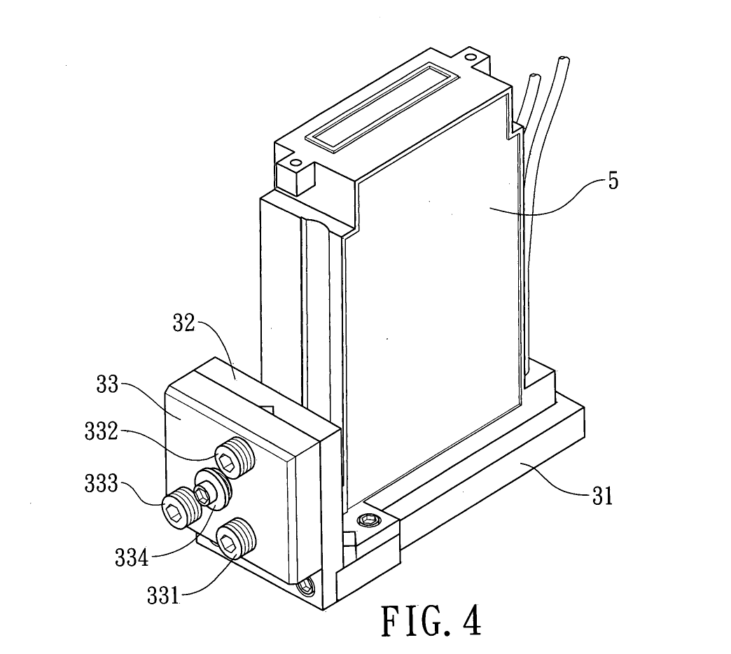

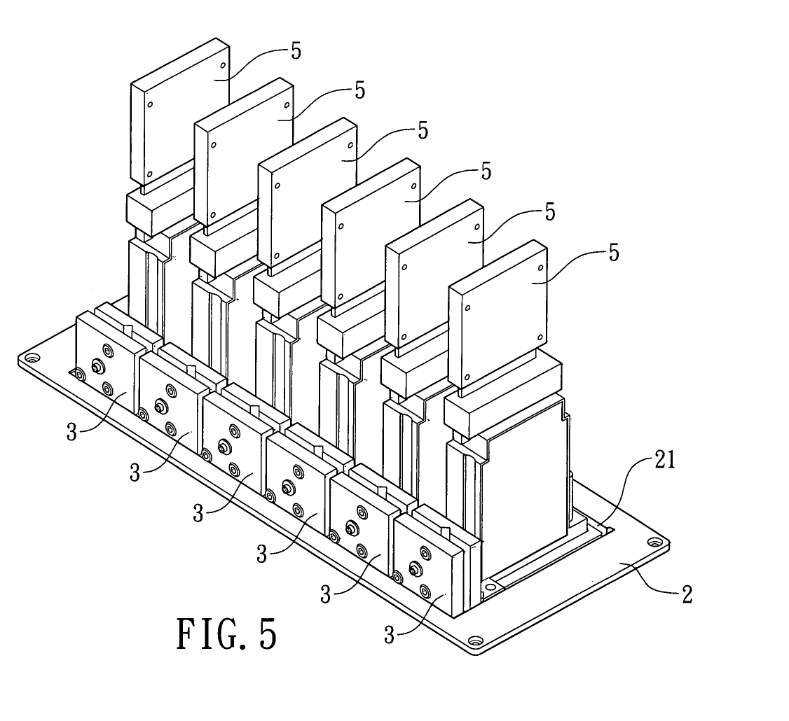

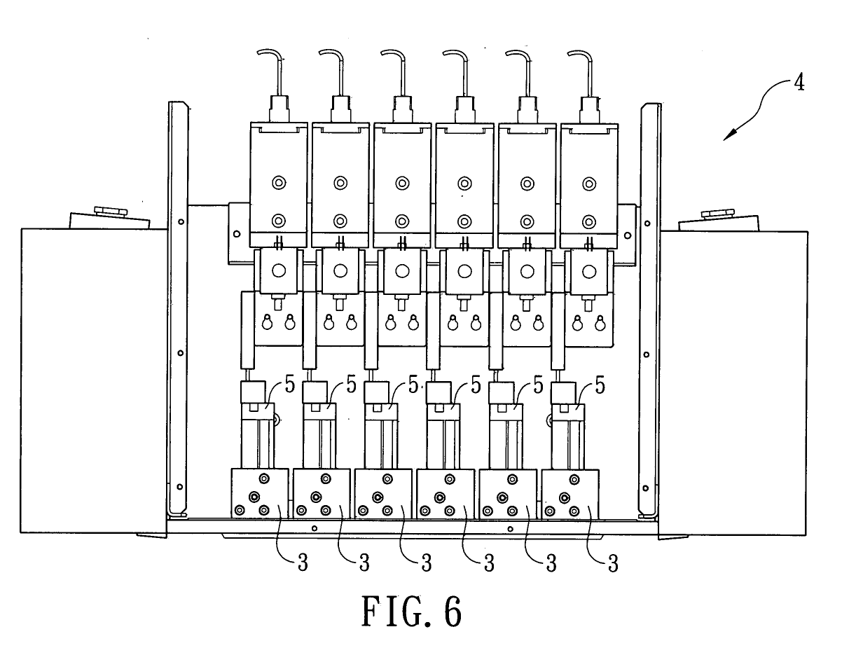

Referring to FIGS. 1 to 6, the adjusting device 1 for adjusting printing heads 5 of inkjet printing machine comprises a base 2 connected to a printing unit 4 and the base 2 has an engaging space 21 with which a plurality of printing assemblies 3 are respectively engaged. Each printing assembly 3 includes a bottom board 31 and an end wall 32 is connected to an end of the bottom board 31. The bottom board 31 has a through hole 312 and the printing head 5 is engaged with the through hole 312. A connection board 33 is connected to an end wall 32 and will be described hereinafter.

A first adjusting member 331, a second adjusting member 332, a third adjusting member 333 are three screws which respectively and threadedly extend through the end board 33, and contact against the end wall 32. The first and second adjusting members 331, 332 are located on an imaginary vertical line on the end board 33. The third adjusting member 333 is located on an imaginary horizontal line on which the first adjusting member 331 is located. Accordingly, the first, second and third adjusting members 331, 332, 333 are located at three peaks of an imaginary right triangle on the end board 33. A fourth adjusting member 334 extends through a center of weight of the right triangle and is threadedly fixedly to a threaded hole 321 defined in the end wall 32 so as to connect the end board 33 to the end wall 32. The fourth adjusting member 334 includes a bolt 3341 with a spring 3342 and a washer 3343 mounted to the bolt 3341.

The first adjusting member 331 can adjust the printing head 5 back and forth along a longitudinal axis of the adjusting assembly 3. The second adjusting member 332 adjusts the printing head 5 up and down. The third adjusting member 333 adjusts the printing head 5 left and right. After the printing head 5 is adjusted to a desired position, the fourth adjusting member 334 is then rotated to securely connect the end board 33 to the end wall 32.

The individual printing head 5 can be adjusted as needed and the adjustment is available in three directions so that the quality of printing can be controlled precisely.

While we have shown and described the embodiment in accordance with the present invention, it should be clear to those skilled in the art that further embodiments may be made without departing from the scope of the present invention.

What is claimed is:

1. An adjusting device for adjusting printing heads of inkjet printing machine, the adjusting device comprising:
a base connected to a printing unit and having an engaging space;
a plurality of printing assemblies respectively engaged with the engaging space of the base and each printing assembly having a printing head connected thereto, each printing assembly having a connection board connected to an end wall thereof, and
a first adjusting member, a second adjusting member, a third adjusting member and a fourth adjusting member respectively connected to the connection board of each printing assembly, the first, second and third adjusting members extending through the end board and contacting against the end wall so as to adjust the printing head, the first, second and third adjusting members being located at three peaks of an imaginary right triangle on the end board, the fourth adjusting member being located at a center of weight of the imaginary right triangle and fixedly connected to the end wall.

2. The device as claimed in claim 1, wherein each printing assembly includes a bottom board and the end wall is connected to an end of the bottom board, the bottom board has a through hole and the printing head is engaged with the through hole, the end wall includes a threaded hole with which the fourth adjusting member is connected so as to connect the end board to the end wall.

3. The device as claimed in claim 1, wherein the first, second and third adjusting members are three screws and the fourth adjusting member includes a bolt, a spring and a washer mounted to the bolt.

4. The device as claimed in claim 1, wherein the first and second adjusting members are located on an imaginary vertical line on the end board and the third adjusting member is located on an imaginary horizontal line on which the first adjusting member is located.

5. The device as claimed in claim 1, the first adjusting member adjusts the printing head back and forth along a longitudinal axis of the adjusting assembly, the second adjusting member adjusts the printing head up and down, the third adjusting member adjusts the printing head left and right.
